(19) United States
(12) Patent Application Publication
(10) Pub. No.: US 2010/0099072 A1
(43) Pub. Date: Apr. 22, 2010

(54) METHOD AND APPARATUS FOR PRESENTING AGGREGATED DATA FOR INSTRUCTIONAL PURPOSES

(75) Inventors: Albert L. Abrahamson, Yorktown, VA (US); Corey E. Brady, Weston, FL (US); Mark D. Fry, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/603,368

(22) Filed: Oct. 21, 2009

Related U.S. Application Data
(60) Provisional application No. 61/107,191, filed on Oct. 21, 2008.

(51) Int. Cl. G09B 7/00

(52) U.S. Cl. 434/362

(57) ABSTRACT

A method and apparatus for presenting aggregated data for instructional purposes. The method includes retrieving student responses, determining at least one bucket type and, if needed, changing the algorithmic criteria defining the at least one bucket type, aggregating the responses according to bucket type; and utilizing the aggregated responses to view or present at least one response in a different representation.

### CROSS-REFERENCE TO RELATED APPLICATIONS

This application claims benefit of U.S. provisional patent application Ser. No. 61/107,191, filed Oct. 21, 2008, which is herein incorporated by reference.

### BACKGROUND OF THE INVENTION

1. Field of the Invention

Embodiments of the present invention generally relate to a method and apparatus for presenting aggregated data from handheld devices, such as, a calculator in a classroom setting for instructional purposes.

2. Description of the Related Art

Major problems for a teacher in teaching a class of students are soliciting, observing, assimilating, and adapting to what every student thinks in a timely fashion. This is particularly true in “cumulative knowledge” subjects, such as, mathematics and science where students may have failed to fully grasp key concepts in subtle ways or may hold misconceptions that are difficult for a teacher to detect, but which can severely inhibit their learning.

Networked classroom systems, such as, TI-Navigator & simpler “Clicker-type” systems, help solve this problem by providing rapid gathering, aggregation, and display of student responses. Currently, these types of systems are limited when answers to questions are not in multiple choice form or the answers are limited to a defined set of choices. For example, the simpler “Clicker-type” systems only allow highly structured responses, such as, multiple choice or numeric answers to a question. More advanced systems (such as TI-Navigator 3.0), which allow for more answers, are limited to provide simple text matching software tools to aggregate and display such answers.

Other types of systems, such as, those for homework over the internet, also exist to gather and aggregate student work. These may provide text-matching capability and also approximate rudimentary sorting for equivalent mathematical expressions, but such systems are not intended for real-time, in-class use. For a mathematics or science teacher, there currently is no comprehensive solution to in-class live-search and display of patterns in student responses, with aggregation into conceptually meaningful categories.

Such systems do not offer tools to present the data in a useful way. For example, in the context of mathematics classrooms, a common activity is the solution of problems for which (a) there may be more than one valid representation to reach a solution for the mathematical problem posed to students (b) there may be more than one valid representation which facilitates student understanding and reasoning of the solution (c) there may be a need to make connections between procedures and representations to move the student from procedural knowledge to conceptual understanding. Further, in mathematics and science, it is critical to collect data from the representational systems used by those disciplines. Fortunately, there are technologies that allow students to express their thoughts in different representational systems. For example, these range from the ubiquitous graphing calculator, to a variety of personal computing devices used by students to express or capture results, work process, or thinking, to networked or online systems with laptops or desktop computers.

Exploring other representations of intelligently aggregated data on that subset can be a powerful way to focus on a concept or misconception using real-time classroom responses. Therefore there is a need for a method or apparatus that can take a class set of data, constrain to a subset, and then leverage that subset to illuminate a concept. For example, simply graphing all submitted equations is not as useful as graphing all equations that have a particular slope.

Therefore, there is a need for an improved method and/or apparatus for presenting aggregated data for instructional purposes.

### SUMMARY OF THE INVENTION

Embodiments of the present invention generally relate to a method and apparatus for presenting aggregated data for instructional purposes. The method includes retrieving student responses, determining at least one bucket type and, if needed, changing the algorithmic criteria defining the at least one bucket type, aggregating the responses according to bucket type; and utilizing the aggregated responses to view or present at least one response in a different representation.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. It is also to be noted that a computer readable medium is any medium that is utilized by a computer for data executing, archiving, storage, deletion or the like.

FIGS. 1a-1d depict embodiments of aggregations and presentations of data from a set of student responses, based on some criteria and moving the set to a different representation;

FIGS. 2a-2f depicts other embodiments of aggregations and presentations of data from a set of student responses based on some criteria, and demonstrating erroneous mathematical operations in a different representation;

FIG. 3 depicts an embodiment of a method for presenting aggregated data for instructional purposes;

FIG. 4 depicts another embodiment of a method for presenting aggregated data for instructional purposes; and

FIG. 5 depicts yet another embodiment of a method for presenting aggregated data for instructional purposes;

FIG. 6 depicts an embodiment of a system for aggregating data for instructional purposes; and

FIG. 7 depicts and embodiment of an apparatus for aggregating data for instructional purposes.

### DETAILED DESCRIPTION

The method and apparatus for presenting aggregated data for instructional purposes, utilizes aggregated data, where such aggregation is defined by some criteria using a math engine, such as, CAS, with a parsing algorithm, to transform such data to different representation. Thus, the method and apparatus for presenting aggregated data from a calculator may produce various forms of mathematical presentation derived through the process of intelligent data aggregation and utilizing different representations.

A user, who may be a teacher, may choose to change the representation of a set of student responses, such as, show the graph of the function, of any of the following:
All responses
Any explicitly binned responses
Any implicitly binned responses
Any individual response

In some cases, responses, such as, expressions or equations can also have process data correlated with it. Therefore, the user may also choose to move all or some of the process to another representation as well. For example, the user solves an equation and has 5 steps. Graphing each step can reveal a mistake graphically.

Note that the term bin or bucket refers to a grouping of data. The aggregation, representation, and presentation utilized, search factors, and subject matter, may vary according to the embodiment presented. Even though this description utilizes embodiments depicting mathematical grouping, this invention may be related to other data retrieved or received, such as, equations for chemical reactions, geometric constructions, electric circuits, free-body diagrams in mechanics, structures of molecules, operations of biological cells, and the like. In these cases “graphing” or “graphical representation” may also imply two- or three-dimensional visualizations of complex phenomena, relevant to conceptual depictions of scientific, engineering, medical, business, or other models, appropriate to the field or discipline in question.

To change the representation of the process data, the user may be able to choose:
All responses
Any explicitly binned responses
Any implicitly binned responses
Any individual response as well as being able to choose data without consideration of the binned information:
All responses
Any individual response
Any set of responses based on some other criteria (e.g. all of the students assigned to a set in the roster of the network)

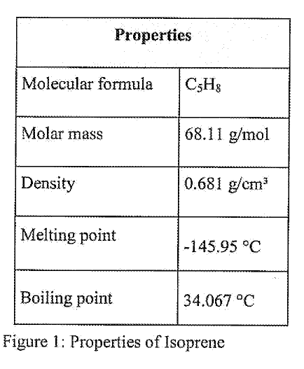

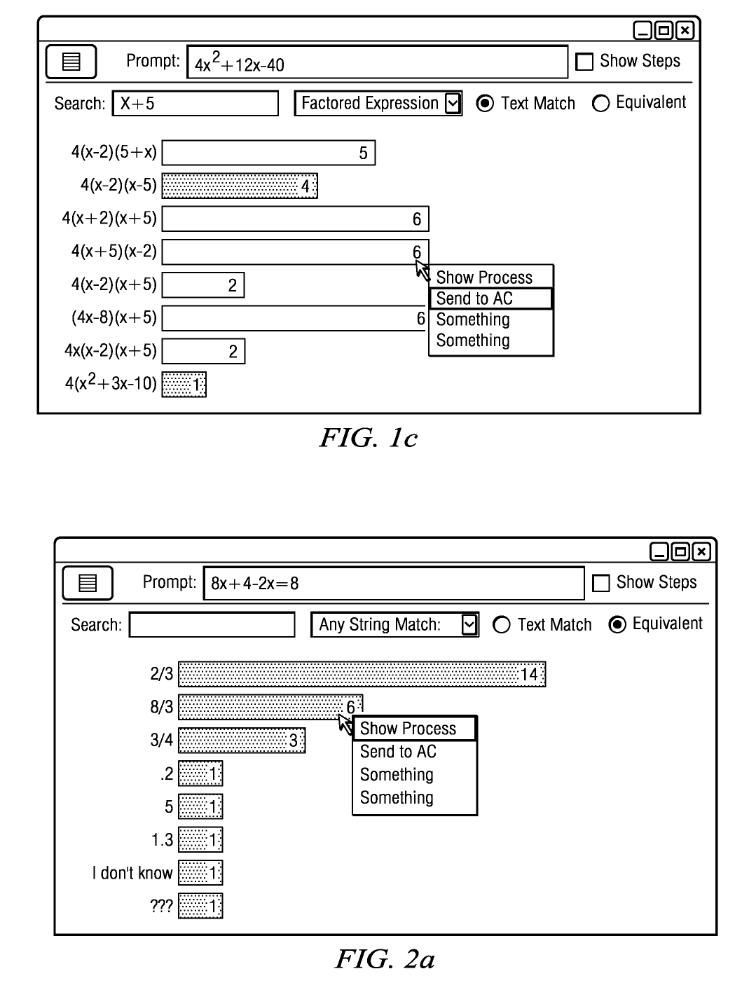

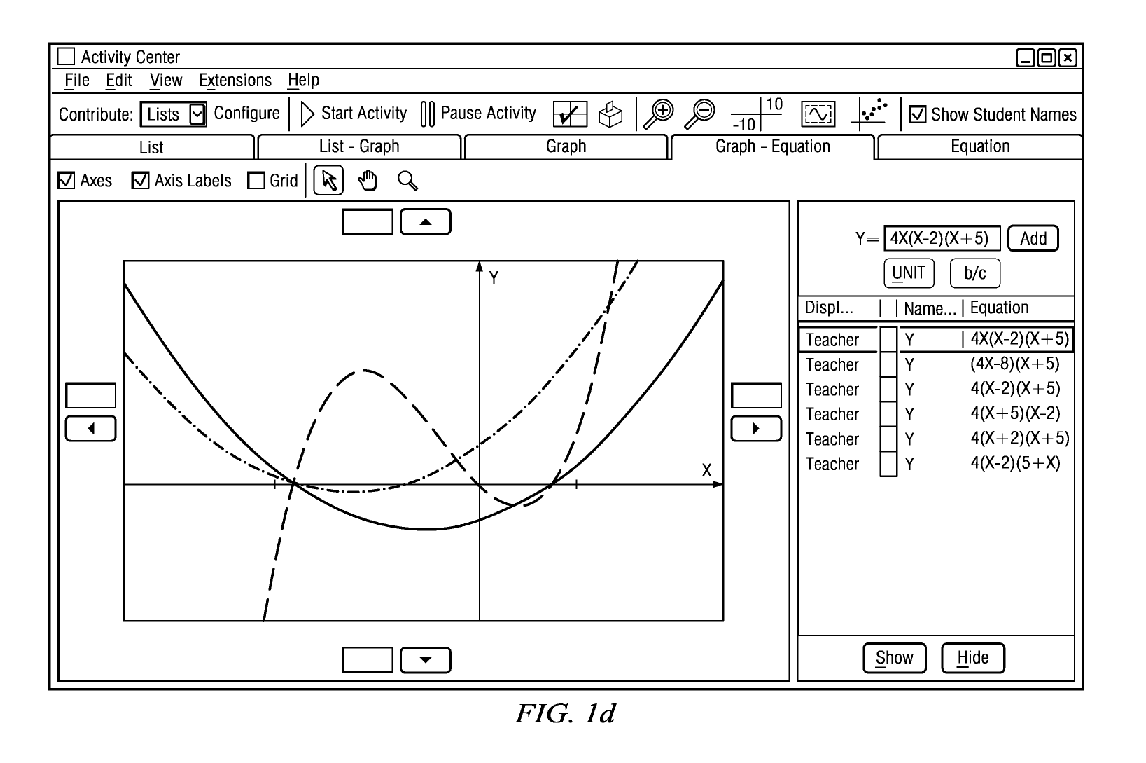

FIGS. 1a-1d depict embodiments of aggregations and presentations of data from a set of student responses, based on some criteria and moving the set to a different representation. FIG. 1 a depicts the aggregation of data that relates to the equation 4x²+12x−40, to which eight (8) bins of responses are defined by the method and/or apparatus. The teacher is able to search for the term 4(x+5)(x−2), as shown in FIG. 1b, and the factor x+5, as shown in FIG. 1b. The teacher is also able to show the steps of the solution, select the bin of responses from students to be shown in a different representation, discuss information anonymously about a student's answer and the like, as shown in FIG. 1c. Finally, as shown in FIG. 1d, the teacher is able to show the graphical representation of the selected student responses, comparing and contrasting the results, thus, visually showing the students the differences and commonalities between wrong and right answers.

In one embodiment, the data is collected through the technology of a response system or classroom network. Such a system or network may support open-ended text generation. Data collected from a student devices may include, but is not limited to, the following Types:
1. Response as an expression
2. Response viewed as an equation
3. Response as a series of steps in the algebraic transformation of an expression (e.g. steps to simply an expression)
4. Response as a series of steps in the algebraic transformation of an equation (e.g. steps to solve an equation for a specific variable)
5. Response viewed as a graph
6. Response as a geometric object or construction (point, line, polygon, etc.)

The system structure and/or hardware components, within which a teacher receives the data for instructional purposes, may range across a large number of physical, electronic, and communications configurations. For example, a teacher may receive data from a classroom network of calculators, handheld computers, laptops, notebooks, desktops, or the like. In one embodiment, the data may be transmitted over a dedicated wired or wireless classroom network, over the internet from a “virtual” classroom, via a “homework” system, asynchronously in a distance learning context, and the like. The data may relate to a question asked, tasks or activities assigned to students, and the like.

Through the technology of a math engine, such as, a computer algebra system (CAS) and intelligent parsing tools, it is possible to aggregate data either explicitly, which is when the responses fitting a certain criteria are represented by a single element, such as, a bar in a bar chart, or implicitly, which is when the responses fitting a certain criteria are represented across the current aggregation of responses through highlighting or some other mechanism calling out those responses.

In one embodiment, the data may relate to graphing expressions, equations or the like. This invention recognizes that expressions that can be aggregated and analyzed using a math engine, such as, a CAS engine and intelligent parsing algorithms, which then defines that set of responses to be graphed. There is a transformation between the aggregated expressions and the hand-off of the graphing utility, which redefines expressions as functions. For example, the user submits (x+2)(x+3) as their expression, this will get graphed as f(x)=(x+2)(x+3) or y=(x+2)(x+3). This transformation is then passed to the graphing utility for immediate viewing.

If the data relates to an equation that is designated to be graphed, the equations may or may not need to be transformed depending on the graphing utility. For example, the user submits y/(x+2)=(x+3) as their equation, this may not need to be algebraically manipulated if the graphing utility manages implied functions in this form or the equation may need to be transformed to y=(x+2)(x+3) when required by the graphing utility. This transformation is then passed to the graphing utility for immediate viewing.

If the data relates to a series of transformations on an expression that are designated to be graphed, each of the individual steps is defined as a set of functions related to one another. This transformation is then passed to the graphing utility for immediate viewing. In such a case, the left side and right side of each of the individual steps may be defined as a set of functions related to one another.

For example, the user solves for 2x+1=3x−2
Step 1: 2x+1=3x−2
Step 2: 1=x−2
Step 3: 3=x
Final Answer: x=3

The equations transformed and graphed may be:
Y1=2x+1
Y1=3x−2
Y2=1
Y2=x−2
Y3=3
Y3=x
X=3

In this last case, if all of the steps are valid, the intersection points of each pair of equations will all lie on the vertical line x=3. This transformation is then passed to the graphing utility for immediate viewing.

In one embodiment, the data may relate to graphical geometric representations of expressions and equations. If the data relates to expressions, then it can be designated to be represented in other forms, which includes geometry, manipulative concepts, such as, Algebra Tiles, etc. For example, the user submits (x+2)(x+3) as their expression, this expression can be applied to a representation in the form of:
Electronic form of Algebra Tiles
Dimensions of a rectangle in a Geometry solution
etc.

In one embodiment, the data may relate to transformation steps of an expression, which may also be designated but rather as a series of graphical representations, each step being represented by one representation.

Thus, it is possible to make a connection between other representations that are used as aids and concept building mechanism in the classroom. Likewise, a graphical form of these representations can be transformed back into algebraic symbolic form. The use of a special-purpose CAS engine combined with parsing algorithms may make the connection between two electronic forms.

In one embodiment, the data relates to a graphed function. If the data relates to a graph, the graph may be supported by a function. However, what is different from data discussed above is that the user views the math object as a graph rather than an equation. The user may click on a particular representation of a graphed function as a way to select all equivalent submitted functions, which may or may not be in the same algebraic form. In such a case, the user may want to grab a set of graphed functions and pass the set back to a form which can view and analyze the algebraic form. Once in algebraic form, additional aggregation may take place and another subset is then graphed.

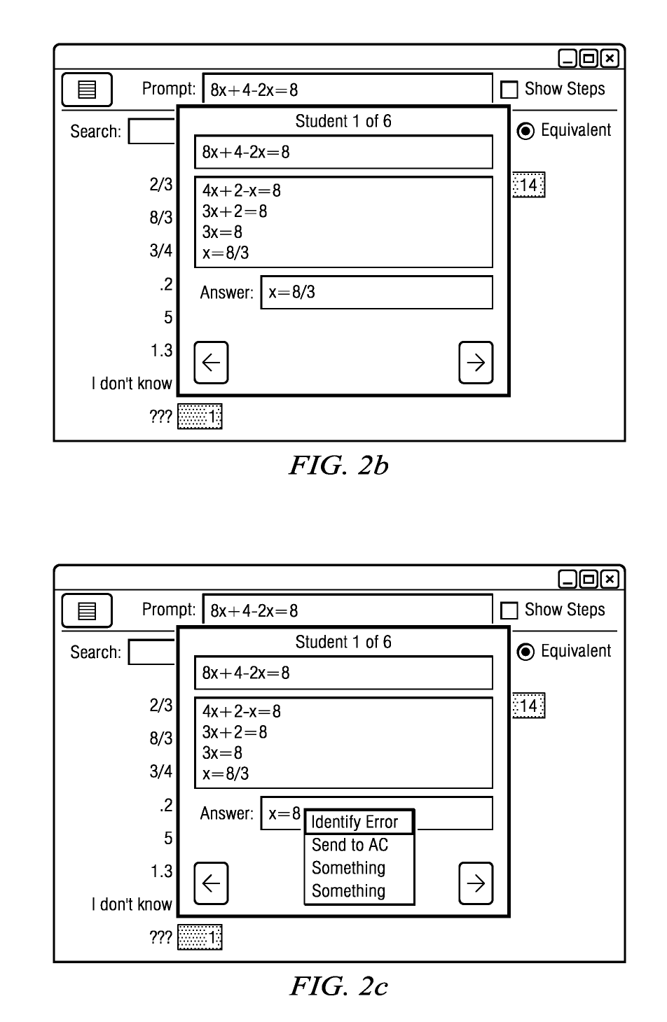

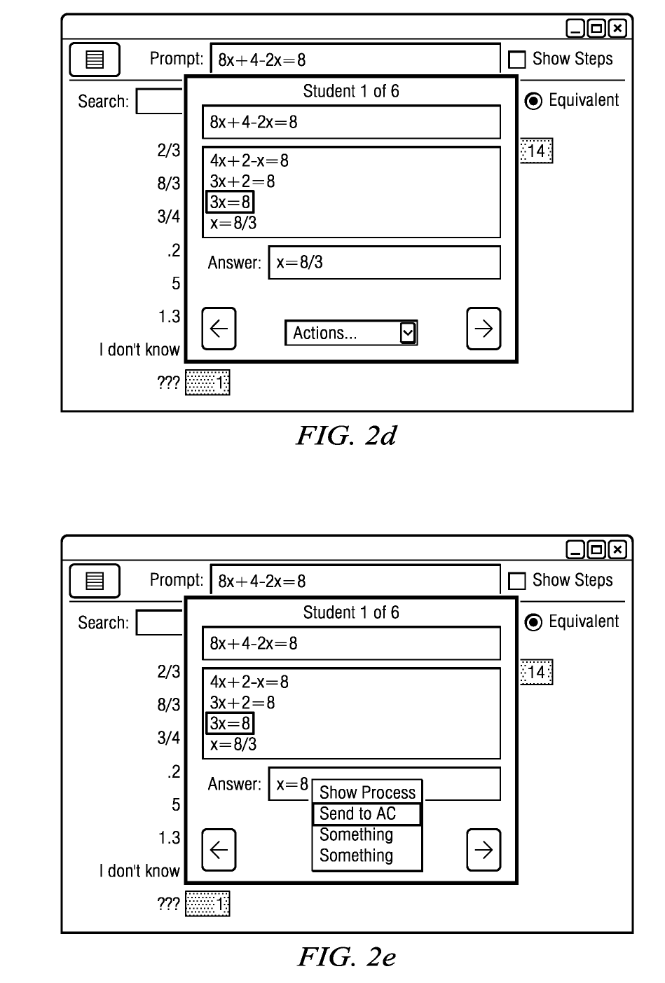

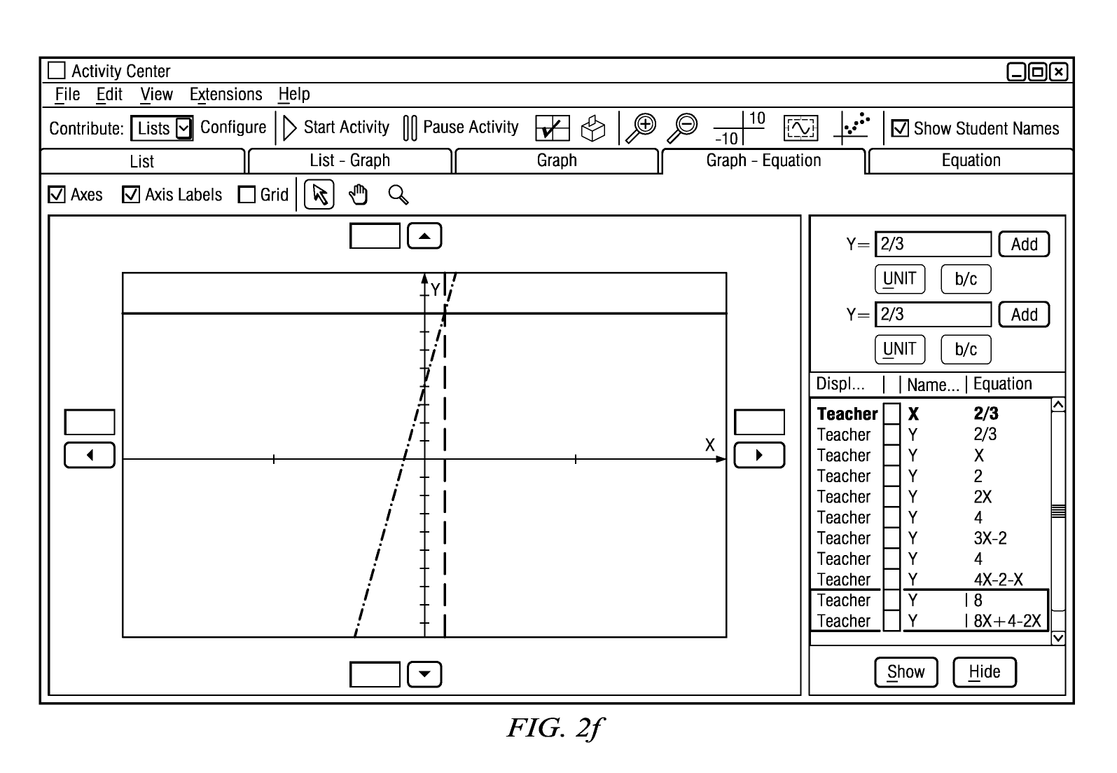

FIGS. 2a-2f depicts other embodiments of aggregations and presentations of data from a set of student responses based on some criteria, and demonstrating erroneous mathematical operations in a different representation. FIG. 2a shows the aggregation, FIGS. 2b-2e show the equation analysis relating to a group of the aggregated data and FIG. 2f shows a graphical representation of the analysis.

There are two ways to think of converting a graphed function into algebraic form:
a. A graphed function is represented as a function
b. A graphed function is represented as an expression (e.g. the y=is stripped from the equation y=2x+1 resulting in the expression 2x+1)

Hence, the user may want to have a choice of expression or function on this conversion back to the symbolic form based on the starting point, for example, expression→graph→expression.

In another embodiment, the data may relate to geometric objects. When a type of data relates to a geometric object, the object may have an underlying property. For example, a rectangle has the properties of width, height, perimeter, area, etc., a point can have a coordinate location, a geometric line can have slope or characteristics or may be perpendicularity to another line. Furthermore, points and polygons can be defined by matrices and other symbolic representations depending on the graphing system. As such, in one embodiment, the user may choose to present the data relating to an expression from an algebraic format to a graphed function, algebraic to geometric and geometric to other representations, etc.

Hence, such an apparatus and/or method recognizes that a set of student responses in this form can be aggregated based on the underlying characteristics of the objects using a math engine and intelligent parsing techniques. The aggregated data is then transformed to another representation. For example, depending on the activity, a teacher might collect in a single bin all contributed rectangles that have the same length, the same width or the same area. Based on any one of these choices, different relations between the rectangles may be explored using multiple representations to support the exploration.

Therefore, after aggregating data utilizing a math engine and intelligent parsing, a user is enabled to establish connections among the math objects based on analysis and between different environments and views (representations) onto those objects, thus, offering a broad a view of moving mathematical objects through “multiple representations.”

Such analysis, which can occur in real-time, allows for increased energetic discussions about students' work and is especially helpful during class when the solutions and errors are fresh in the students' minds. This has a positive effect on learning in that the students get immediate feedback about their strengths and weaknesses. In one embodiment, the work may be anonymous; thus, the classroom discussion may proceed without embarrassing the individual students whose work is being discussed. Taking aggregated data to different environments to view such data is time consuming and without the technology to support these scenarios, making it difficult to make real-time connections between representations of binned data. The representation environments are dynamic. Both aggregation and linking add teaching and learning value beyond what could ever be achieved using static paper-and-pencil artifacts.

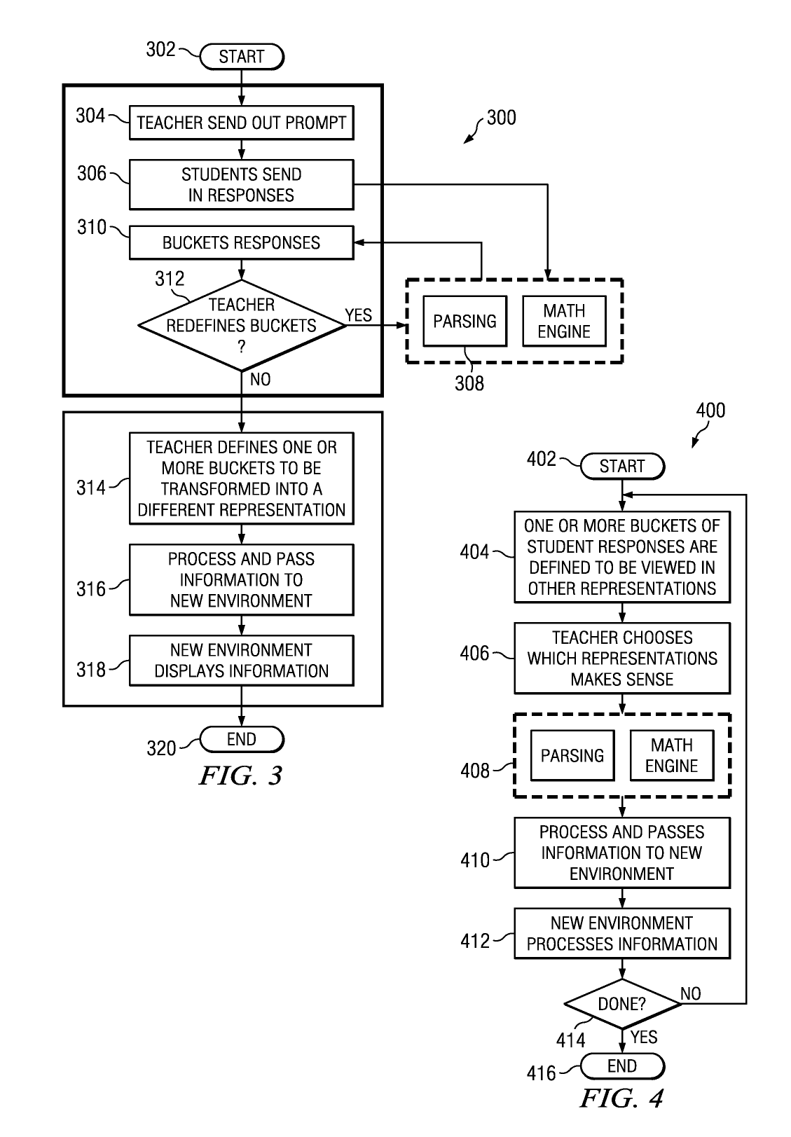

FIG. 3 depicts an embodiment of a method 300 for presenting aggregated data for instructional purposes. The method 300 starts at step 302 and proceeds to step 304. At step 304, the teacher sends out a prompt requesting the students' responses or presenting a problem. At step 306, the teacher receives the students' responses to the prompt. At step 308, the system parses the responses and utilizes a math engine to bucket the responses. At step 310, the responses are bucketed. At step 312, the teacher may choose to refine the buckets. If the teacher opts to refine the buckets, the method 300 proceeds to step 308 to parse the response and to utilize the math engine for refining the buckets. Otherwise, the method 300 proceeds to step 314. At step 312, the teacher sets the algorithmic criteria defining one or more buckets to be transformed into a different representation. At step 316, the method 300 processes and parses information according to the new environment defined. At step 318, a new environment displays the information. The method 300 ends at step 320.

FIG. 4 depicts another embodiment of a method 400 for presenting aggregated data for instructional purposes. The method 400 starts at step 402 and proceeds to step 404. At step 404, one or more buckets of student responses are defined to be viewed in other representations. At step 406, the teacher chooses which representations make sense, or are appropriate from an instructional or conceptual perspective. At step 408, the method 400 parses the responses and utilizes a math engine. At step 410, the method 400 processes and passes information the information to the newly requested environment. At step 412, the information is displayed in the new environment. At step 414, the method 400 determines if there are more responses or buckets to process. If there are more data to process, the method 400 proceeds to step 404; otherwise, the method 400 proceeds to step 416. The method 400 ends at step 416.

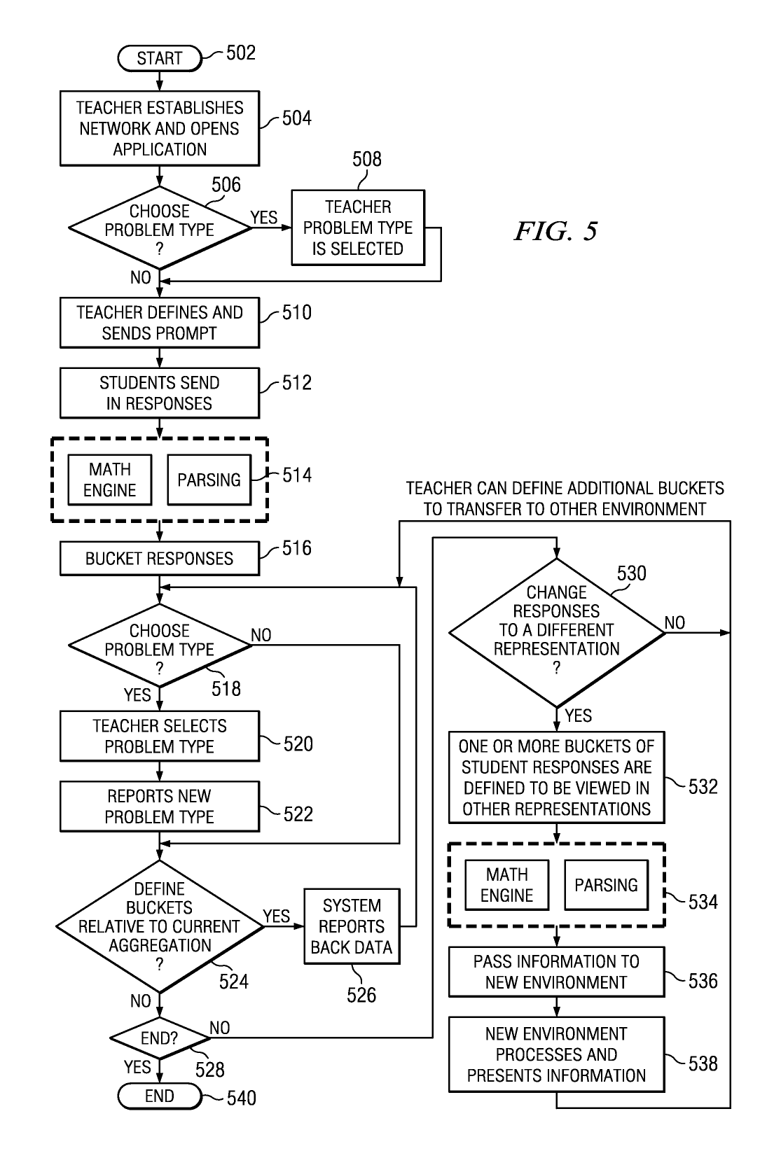

FIG. 5 depicts yet another embodiment of a method 500 for presenting aggregated data for instructional purposes. The method 500 starts at step 502 and proceeds to step 504. At step 504, the teacher may establish a network and opens application to allow for classroom data exchange. At step 506, the method 500 determines if the teacher chooses a problem type; examples of problem types are defined above. If the teacher chooses the problem type, the method 500 proceeds to step 508, wherein the teacher's problem type is selected; otherwise, the method 500 proceeds to step 510. At step 510, the teacher defines and sends prompt. At step 512, the students send in responses. At step 514, the method 500 parses and utilizes a math engine to prepare for response bucketing. At step 516, the method 500 buckets the responses. At step 518, the method 500 determines if the problem type is to be selected. If the problem type is to be chosen, the method 500 proceeds to step 520, wherein the teacher selects the problem type. The method 500 may parse and utilize a math engine to switch to the new problem type. From step 520, the method proceeds to step 522, wherein the method 500 reports the new problem type and then proceeds to step 524. If the problem type is not to be selected, the method 500 proceeds to step 524. At step 524, the method 500 determines if alternate and/or refined buckets are needed relative to the current aggregation. If such buckets are needed, the method 500 proceeds to step 526 wherein it may parse and utilize a math engine, whence the method 500 reports the data; otherwise, the method 500 proceeds to step 528. From step 526, the method 500 proceeds to step 518.

At step 528, the method 500 determines if the aggregation is ended. If it is not ended, the method 500 proceeds to step 530; otherwise, the method 500, proceeds to step 540. At step 530, the method 500 determines if the responses need to be changed to a different representation. If the responses need to be changed to a different representation, the method 500 proceeds to step 532; otherwise, the method 500 proceeds to step 518. At step 532, one or more buckets of students' responses are viewed in another representation. At step 534, the method 500 parses and utilizes a math engine to get data into a form to be received by the new environment. At step 536, the method 500 passes the data to the new environment. At step 536, the new environment processes and presents the information. From step 536, the method 500 proceeds to step 518. The method 500 ends at step 540.

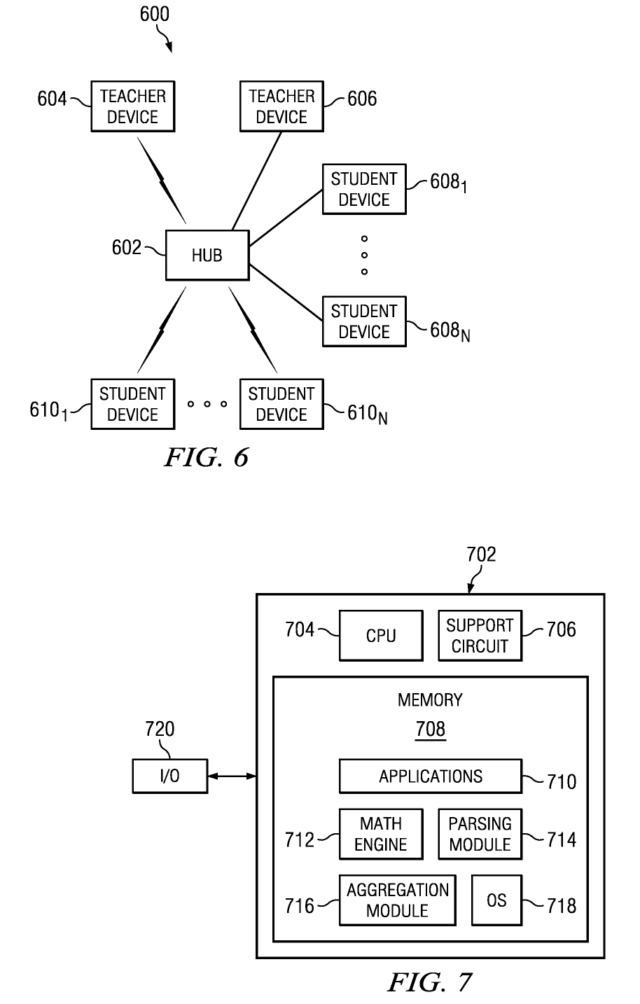

FIG. 6 depicts an embodiment of a system 600 for aggregating data for instructional purposes. The system 600 includes a hub 602, wireless teacher device 604, teacher device 606, student device 608 (608₁-608_{N}) and wireless student device 610 (610₁-610_{N}). The hub 602 facilitates communication between the student devices 608, 610 and the teacher devices 604, 606. The hub 602 may be a personal computer, a laptop, a handheld device or the like. The hub 602 may be utilized as a teacher device or a student device or maybe a dedicated hub for creating a network or facilitating communication. The student devices 608, 610 and the teacher devices 604, 606 may be a personal computer, a laptop, a handheld device or the like.

The wireless teacher device 604 is capable of communicating wirelessly with the hub 602 and the teacher device 608. The teacher device 604, 606 is capable of communicating with the hub 602 and the teacher device 608. If should be noted that the system 600 may include one of a wireless teacher device 604 or a teacher device 606; furthermore, the wireless teacher device 604 and a teacher device 606 maybe combined into the same device that may be utilized wireless or directly coupled to the hub 602. The system 600 may include any number of wireless teacher device 604 or the teacher device 606. The teacher utilized the teacher device 604, 606 to prompt the students and to receive students' responses. The hub 602 and/or the teacher device 604, 606.

The wireless student device 610 is capable of communicating wirelessly with the hub 602 and the teacher device 604, 606. The student device 608, 610 is capable of communicating with the hub 602 and the student device 608. If should be noted that the system 600 may include one of a wireless student device 610 or a student device 608; furthermore, the wireless student device 610 and a student device 608 maybe combined into the same device that may be utilized wireless or directly coupled to the hub 602. The system 600 may include any number of wireless student device 610 or the student device 608. The student utilized the student device 608, 610 to respond and to communicate with the teacher, to receive teachers' prompt.

FIG. 7 depicts and embodiment of an apparatus 702 for aggregating data for instructional purposes. The apparatus 702 includes a central processing unit (CPU) 704, support circuit 706 and memory 708. The CPU 702 may comprise one or more conventionally available microprocessors. The microprocessor may be an application specific integrated circuit (ASIC). The support circuits 706 are well known circuits used to promote functionality of the CPU 704. Such circuits include, but are not limited to, a cache, power supplies, clock circuits, input/output (I/O) 720 device and the like.

The memory 708 may comprise random access memory, read only memory, removable disk memory, flash memory, and various combinations of these types of memory. The memory 308 is sometimes referred to main memory and may, in part, be used as cache memory or buffer memory. The memory 708 may store an operating system (OS) 718, various forms of application 710, a math engine 712, a parsing module 714 and an aggregation module 716. The aggregation module 716 performs any of the methods described in FIGS. 3, 4 and/or 5.

The foregoing embodiments are not intended to represent exhaustive compilations of all possible types of mathematical data and aggregations for instructional purposes. Mathematics and science are a vast fields, so it is clearly not feasible to include all possible such descriptions. While the foregoing is directed to embodiments of the present invention, other and further embodiments of the invention may be devised without departing from the basic scope thereof, and the scope thereof is determined by the claims that follow.

What is claimed is:

1. A method for presenting aggregated data for instructional purposes, the method comprising:
retrieving student responses;
determining at least one bucket type and, if needed, changing the algorithmic criteria defining the at least one bucket type;
aggregating the responses according to bucket type; and
utilizing the aggregated responses to view or present at least one response in a different representation.

2. The method of claim 1, wherein the step of changing the responses comprises at least one of parsing the response or utilizing a math engine.

3. The method of claim 2, wherein the math engine is a CAS engine.

4. The method of claim 1, wherein the method if performed in real-time as the student's response is being retrieved.

5. The method of claim 1, wherein the responses are being retrieved from at least one of a calculator, a handheld computer, a laptop computer, a notebook computer, a desktop computer, a tablet computer, a cellphone, or a media player.

6. The method of claim 1, wherein the responses are being retrieved over at least one of: a dedicated wired network, wireless network, the internet from a “virtual” classroom, the internet via a “homework” system, or the internet asynchronously in a distance learning context.

7. The method of claim 1, wherein the bucket type relates to an environment.

8. The method of claim 7, wherein the environment is at least one of symbolic, graphical, geometric, coordinate grid, model, algebra tiles, chemical equation, vector diagram, molecular model, biological model, physics model, chemical model, geological model, astronomical model, economics model or business model.

9. The method of claim 1, wherein the responses are in at least one of symbolic form, algebraic steps, algebraic expression, equation, graphic form, graphic construction, or model form.

10. The method of claim 1, wherein the responses are triggered by a student's prompt.

11. The method of claim 1 further comprising repeating the steps to view the aggregation different environments.

12. An apparatus for presenting aggregated data for instructional purposes, the comprising:
means for retrieving student responses;
means for determining at least one bucket type and, if needed, changing the algorithmic criteria defining the at least one bucket type;
means for aggregating the responses according to bucket type; and
means for utilizing the aggregated responses to view or present at least one response in a different representation.

13. The method of claim 12, wherein the student responses are retrieved via at least one of a dedicated wired network, wireless network, the internet from a “virtual” classroom, the internet via a “homework” system, or the internet asynchronously in a distance learning context.

14. The apparatus of claim 12, wherein the means for changing the responses comprises at least one of means for parsing the response or means for utilizing a math engine.

15. The apparatus of claim 14, wherein the math engine is a CAS engine.

16. The apparatus of claim 12, wherein the apparatus is utilized in real-time as the student's response is being retrieved.

17. The apparatus of claim 12, wherein the responses are being retrieved from at least one of a calculator, a handheld computer, a laptop computer, a notebook computer, a desktop computer, a tablet computer, a cellphone, or a media player.

18. The apparatus of claim 12, wherein the bucket type relates to an environment.

19. The apparatus of claim 18, wherein the environment is at least one of symbolic, graphical, geometric, coordinate grid, model, algebra tiles, chemical equation, vector diagram, molecular model, biological model, physics model, chemical model, geological model, astronomical model, economics model, or business model.

20. The apparatus of claim 12, wherein the responses are in at least one of symbolic form, algebraic steps, algebraic expression, equation, graphic form, graphic construction, or model form.

21. The apparatus of claim 12, wherein the responses are triggered by a student's prompt.

22. The apparatus of claim 12 further comprising repeating the steps to view the aggregation different environments.

23. A computer readable medium, comprising executable instructions, when executed, perform a method for presenting aggregated data for instructional purposes, the method comprising:
retrieving student responses;
determining at least one bucket type and, if needed, changing the algorithmic criteria defining the at least one bucket type;
aggregating the responses according to bucket type; and
utilizing the aggregated responses to view or present at least one response in a different representation.

24. The computer readable medium of claim 23, wherein the step of changing the responses comprises at least one of parsing the response or utilizing a math engine.

25. The computer readable medium of claim 24, wherein the math engine is a CAS engine.

26. The computer readable medium of claim 23, wherein the method if performed in real-time as the student's response is being retrieved.

27. The computer readable medium of claim 23, wherein the responses are being retrieved from a student's calculator.

28. The computer readable medium of claim 23, wherein the bucket type relates to an environment.

29. The computer readable medium of claim 28, wherein the environment is at least one of symbolic, graphical, geometric, coordinate grid, model, algebra tiles, chemical equation, vector diagram, molecular model, biological model, physics model, chemical model, geological model, astronomical model, economics model, or business model.

30. The computer readable medium of claim 23, wherein the responses are in at least one of symbolic form, algebraic steps, algebraic expression, equation, graphic form, graphic construction, or model form.

31. The computer readable medium of claim 23, wherein the responses are triggered by a student's prompt.

32. The computer readable medium of claim 23 further comprising repeating the steps to view the aggregation different environments.
